(19) United States
(12) Patent Application Publication
(10) Pub. No.: US 2007/0296997 A1
(43) Pub. Date: Dec. 27, 2007

(54) IMAGE PROCESSING APPARATUS, METHOD FOR CONTROLLING IMAGE PROCESSING APPARATUS, AND STORAGE MEDIUM

(75) Inventor: Masakazu Taneda, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/765,929

(22) Filed: Jun. 20, 2007

(30) Foreign Application Priority Data
Jun. 23, 2006 (JP) 2006-173620

(51) Int. Cl. G06K 15/00

(52) U.S. Cl. 358/1.14

(57) ABSTRACT

A piece of information is obtained from an encoded image on each of pages, and the transmission of the pages is controlled on the basis of the coincidence between the pieces of information obtained from the pages. Therefore, during transmission of images to a certain destination, the transmission of a wrong image can be prevented without adding correct transmission destinations to all the images as encoded images.

### BACKGROUND OF THE INVENTION

1. Field of the Invention

The present invention relates to an image processing apparatus, a method for controlling the image processing apparatus, and a storage medium.

2. Description of the Related Art

Offices handling business transactions with a plurality of companies may encounter a problem in that during transmission of images of a plurality of pages to a certain company, a confidential image relating to a different company may be inadvertently transmitted to the company. A technique for preventing such inadvertent transmission is disclosed in Japanese Patent Laid-Open No. 3-50958, in which transmission destinations are stored in images in advance. Japanese Patent Laid-Open No. 2001-4519 discloses a technique in which an address database storing the relationship between image types and destination addresses is used to determine a read image and transmit the image to a predetermined destination.

In the technique disclosed in Japanese Patent Laid-Open No. 3-50958, however, a correct transmission destination is designated in advance each time an image is created to prevent the transmission of a confidential image to a wrong transmission destination, which inconveniences users because the transmission destination is not always known when an image is created.

In the technique disclosed in Japanese Patent Laid-Open No. 2001-4519, the correspondence between image types and transmission destinations are designated in advance to prevent the transmission of a confidential type of image to a wrong transmission destination. However, it is not easy to determine the correspondence between image types and transmission destinations.

It is therefore desirable to prevent transmission of a confidential image to a wrong transmission destination using a simple mechanism.

### SUMMARY OF THE INVENTION

The present invention provides an image processing apparatus including a first obtaining unit configured to obtain information by decoding an encoded image included in a document image on a first page; a second obtaining unit configured to obtain information by decoding an encoded image included in a document image on a second page different from the first page; and a controller configured to determine whether or not the information obtained by the first obtaining unit and the information obtained by the second obtaining unit coincide with each other and to perform control to prohibit transmission of at least one of the document image on the first page and the document image on the second page when it is determined that the information obtained by the first obtaining unit and the information obtained by the second obtaining unit do not coincide with each other.

Other embodiments, features and aspects of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing an example overall structure of an image forming system.

FIG. 2 is an external view of example inputting and outputting devices of an image forming apparatus.

FIG. 3 is a diagram showing an example overall structure of the image forming apparatus.

FIG. 4 is a diagram conceptually showing tile data.

FIG. 5 is a block diagram of an example scanner image processing unit.

FIG. 6 is a block diagram of an example printer image processing unit.

FIG. 7 is a diagram showing an example copy screen displayed on an operation unit.

FIG. 8 is a flowchart showing an example master-copy creation process.

FIG. 9 is a diagram showing an example transmission screen displayed on the operation unit.

FIG. 10 is a sub-flowchart showing the processing of step S1202 in a flowchart shown in FIG. 12 according to a first embodiment of the present invention.

FIG. 11 is a sub-flowchart showing the processing of step S1202 in the flowchart shown in FIG. 12 according to a second embodiment of the present invention.

FIG. 12 is a flowchart showing an example transmission process according to embodiments of the present invention.

FIG. 13 is a sub-flowchart showing the processing of step S1202 in the flowchart shown in FIG. 12 according to a third embodiment of the present invention.

### DESCRIPTION OF THE EMBODIMENTS

Exemplary embodiments, features and aspects of the present invention will be described with reference to the drawings.

### First Exemplary Embodiment

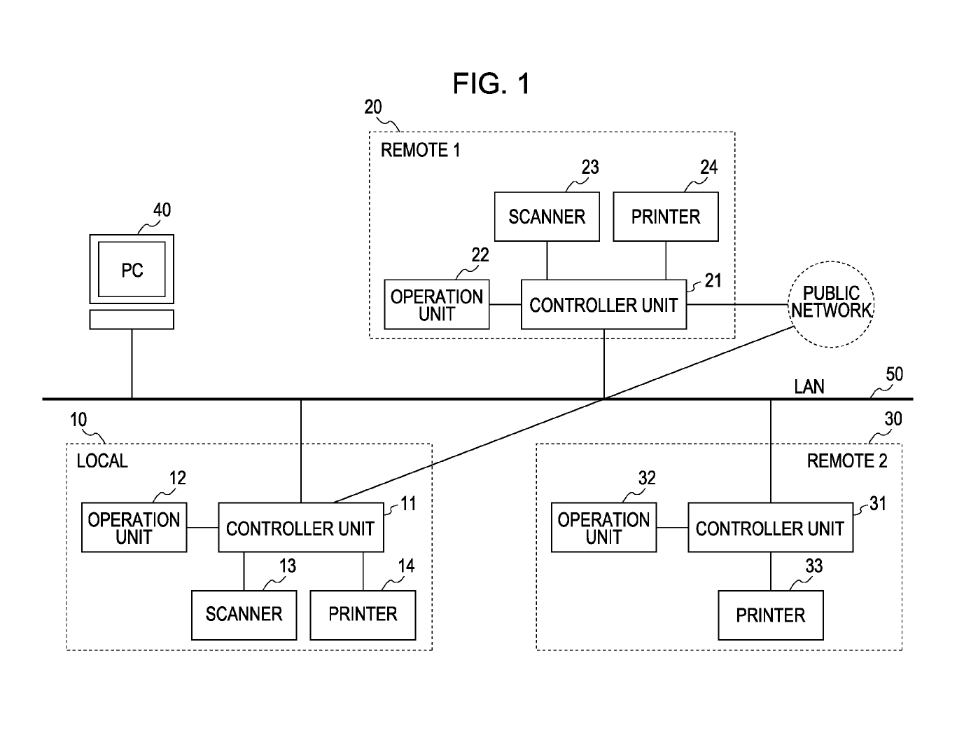

A first embodiment of the present invention will now be described in detail with reference to the drawings. FIG. 1 is a block diagram showing an example structure of a printing system according to the first embodiment of the present invention.

In the system shown in FIG. 1, a host computer (hereinafter referred to as a “PC”) 40 and three image forming apparatuses (10, 20, and 30) are connected to a local area network (LAN) 50. In a printing system according to the present invention, the number of connected apparatuses is not limited to four. In the first embodiment, a LAN is used as a connection method. However, the present invention is not limited thereto, and any other network such as a public wide area network (WAN), a serial transmission system such as USB (Universal Serial Bus), and a parallel transmission system such as Centronics or SCSI (Small Computer System Interface) can also be used.

The PC 40 has a personal computer function. The PC 40 is capable of transmitting or receiving a file or transmitting or receiving e-mail via the LAN 50 or a WAN using FTP (File Transfer Protocol) or SMB (Server Message Block) protocol. The PC 40 is also capable of issuing a printing instruction to the image forming apparatuses 10, 20, and 30 via a printer driver.

The image forming apparatuses 10 and 20 have the similar structures in this instance. The structure of the image forming apparatuses 10 and 20 will be described in detail in the context of the image forming apparatus 10, for the convenience of description.

The image forming apparatus 10 includes a scanner unit 13 serving as an image inputting device, a printer unit 14 serving as an image outputting device, a controller unit 11 controlling the overall operation of the image forming apparatus 10, and an operation unit 12 serving as a user interface (UI).

The image forming apparatus 20 includes a scanner unit 23 serving as an image inputting device, a printer unit 24 serving as an image outputting device, a controller unit 21 controlling the overall operation of the image forming apparatus 10, and an operation unit 22 serving as a user interface (UI).

The image forming apparatus 30 includes a controller unit 31, operation unit 32 and printer 33. The image forming apparatus 30 has only a printing function, and does not include a scanner unit, unlike the image forming apparatuses 10 and 20.

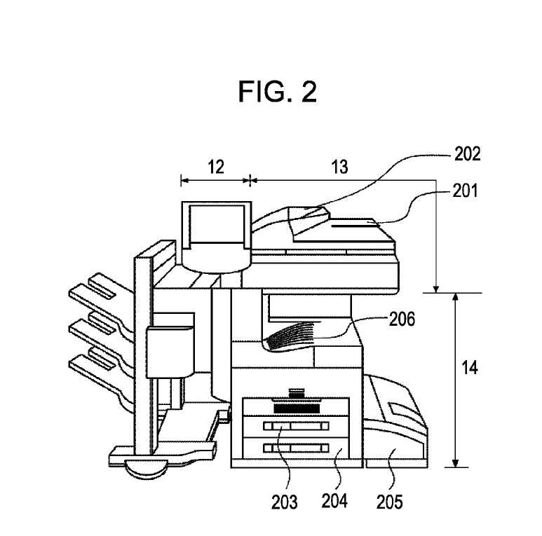

FIG. 2 is an external view of the example image forming apparatus 10. The scanner unit 13 inputs reflected light obtained by scanning an image on an original document with light to a charge-coupled device (CCD) sensor to convert information of the image into an electrical signal. The scanner unit 13 further converts the electrical signal into brightness signals of red (R), green (G), and blue (B), and outputs the brightness signals to the controller unit 11 as image data.

Original documents are placed on a tray 202 of a document feeder 201. When a user gives an instruction to start reading using the operation unit 12, a document reading instruction is issued from the controller unit 11 to the scanner unit 13. In response to the instruction, the scanner unit 13 feeds the original documents one-by-one from the tray 202 of the document feeder 201 to read the original documents. The original documents may be scanned by, instead of automatic feed using the document feeder 201, placing an original document on a glass platen (not shown) and moving an exposure unit.

The printer unit 14 is an image forming device arranged to form the image data received from the controller unit 11 on a sheet of paper. In the first embodiment, an electrophotographic image forming method using a photosensitive drum or photosensitive belt is used. However, the present invention is not limited to this method, and any other printing method such as an inkjet printing method in which ink is ejected from a fine nozzle array to print on a sheet of paper may be used. The printer unit 14 includes a plurality of paper cassettes 203, 204, and 205 for allowing selection between different paper sizes or different paper orientations. Printed sheets of paper are output to a paper output tray 206.

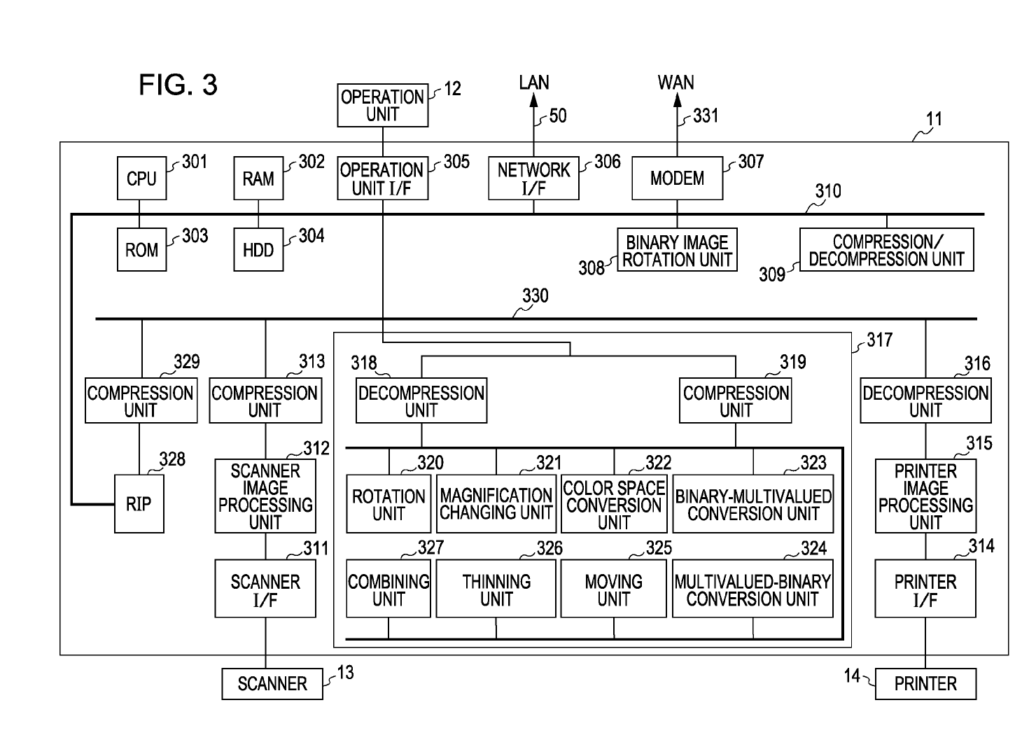

FIG. 3 is a block diagram showing an example structure of the controller unit 11 in the image forming apparatus 10 in more detail.

The controller unit 11 is electrically connected to the scanner unit 13 and the printer unit 14, and is also connected to the PC 40, external devices, and the like via the LAN 50 or a WAN 331. Image data or device information can therefore be input and output.

A central processing unit (CPU) 301 controls overall access to various currently connected devices on the basis of a control program or the like stored in a read-only memory (ROM) 303, and also controls the overall processing performed within the controller unit 11. A random access memory (RAM) 302 is a system work memory used for the operation of the CPU 301, and is also a memory temporarily storing image data. The RAM 302 is formed of a static RAM (SRAM) capable of holding the stored data even after the power is turned off, and a dynamic RAM (DRAM) from which the stored data is deleted after the power is turned off. The ROM 303 stores programs such as a boot program of the image forming apparatus 10. A hard disk drive (HDD) 304 is capable of storing system software and image data.

An operation unit interface (I/F) 305 is an interface unit configured to connect a system bus 310 to the operation unit 12. The operation unit I/F 305 receives image data to be displayed on the operation unit 12 from the system bus 310, and inputs the image data to the operation unit 12. Further, the operation unit I/F 305 outputs information input from the operation unit 12 to the system bus 310.

A network I/F 306 is connected to the LAN 50 and the system bus 310 to input and output information. A modem 307 is connected to the WAN 331 and the system bus 310 to input and output information. A binary image rotation unit 308 converts the orientation of image data to be transmitted. A compression/decompression unit 309 converts the resolution of an image to be transmitted into a predetermined resolution or a resolution corresponding to the performance of the transmission destination. The compression and decompression process is performed using a coding method such as JBIG (Joint Bi-level Image Experts Group), MMR (Modified Modified Read), MR (Modified Read), or MH (Modified Huffman). An image bus 330 is a transmission path for transmitting image data, and is a PCI (Peripheral Component Interconnect) bus or an IEEE (the Institute of Electrical and Electronics Engineers) 1394 bus.

A scanner image processing unit 312 corrects, modifies, and edits image data received from the scanner unit 13 via a scanner I/F 311. The scanner image processing unit 312 determines the type of the received image data, such as a color document or a monochrome document, or a text document or a picture document. The scanner image processing unit 312 adds the determination result to the image data. The additional information is referred to as “attribute data”. The details of the operation of the scanner image processing unit 312 are described below.

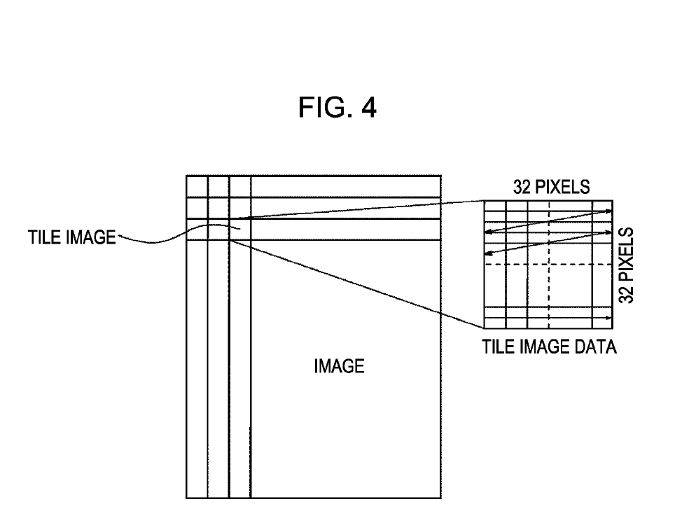

A compression unit 313 receives image data, and divides the image data into blocks each having 32 pixels by 32 pixels. The image data having 32×32 pixels is referred to as “tile data”. FIG. 4 conceptually shows the tile data. In an original document (a paper medium that has not been read), a region corresponding to the tile data is referred to as a “tile image”. The tile data has header information including average brightness information in the 32×32 pixel block and the coordinate position of the tile image on the document. The compression unit 313 further compresses the image data formed of the plurality of tile data. A decompression unit 316 decompresses the image data formed of the plurality of tile data, and converts the decompressed data into raster image data to deliver the raster image data to a printer image processing unit 315.

The printer image processing unit 315 receives the image data delivered from the decompression unit 316, and performs image processing on the image data while referring to the attribute data added to the image data. The image data subjected to image processing is output to the printer unit 14 via a printer I/F 314. The details of the operation of the printer image processing unit 315 are described below.

An image conversion unit 317 performs predetermined conversion on image data. The image conversion unit 317 includes the following processors.

A decompression unit 318 decompresses the received image data. A compression unit 319 compresses the received image data. A rotation unit 320 rotates the received image data. A magnification changing unit 321 converts the resolution of the received image data (for example, from 600 dpi to 200 dpi). A color space conversion unit 322 converts the color space of the received image data. The color space conversion unit 322 can perform processing, such as well-known ground removal using a matrix or table, well-known logarithmic (LOG) conversion (from RGB to CMY), and well-known output-color correction (from CMY to CMYK). A binary-multivalued conversion unit 323 converts the received two-tone image data into 256-tone image data. A multivalued-binary conversion unit 324 converts the received 256-grayscale image data into two-grayscale image data using a technique such as an error diffusion method.

A combining unit 327 combines the received two sets of image data into one set of composite image data. The two sets of image data may be combined by using an average of brightness values of pixels to be combined as the composite brightness value or using a brightness value of a pixel having a higher brightness level as the brightness value of the composite pixel. Alternatively, a darker pixel may be used as a composite pixel. The brightness value of the composite pixel can also be determined by performing an OR operation, an AND operation, or an exclusive OR operation between pixels to be combined. Those combining methods are well known in the art. A thinning unit 326 thins out pixels of the received image to convert the resolution, and generates image data such as ½, ¼, or ⅛. A moving unit 325 adds or removes a margin space to or from the received image data.

A raster image processor (RIP) 328 receives intermediate data generated on the basis of PDL (Page Description Language) code data transmitted from the PC 40 or the like, and generates bitmap data (multivalued data). A compression unit 329 is in communication with the RIP 328 and the image bus 330.

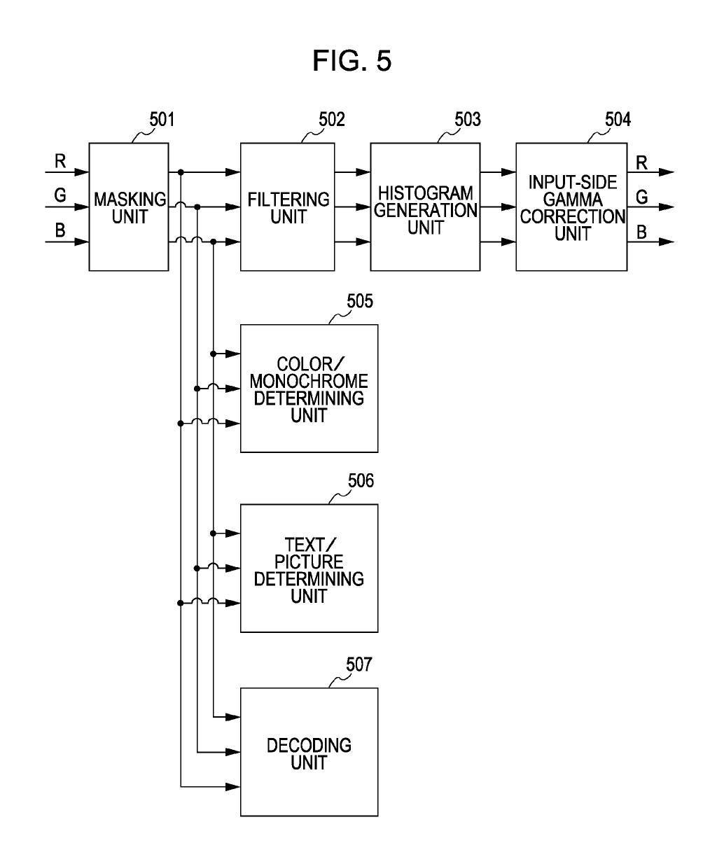

FIG. 5 shows an example internal structure of the scanner image processing unit 312. The scanner image processing unit 312 receives image data formed of eight-bit brightness signals of RGB colors. A masking unit 501 converts the brightness signals into standard brightness signals that do not depend on the colors of filters of the CCD sensor.

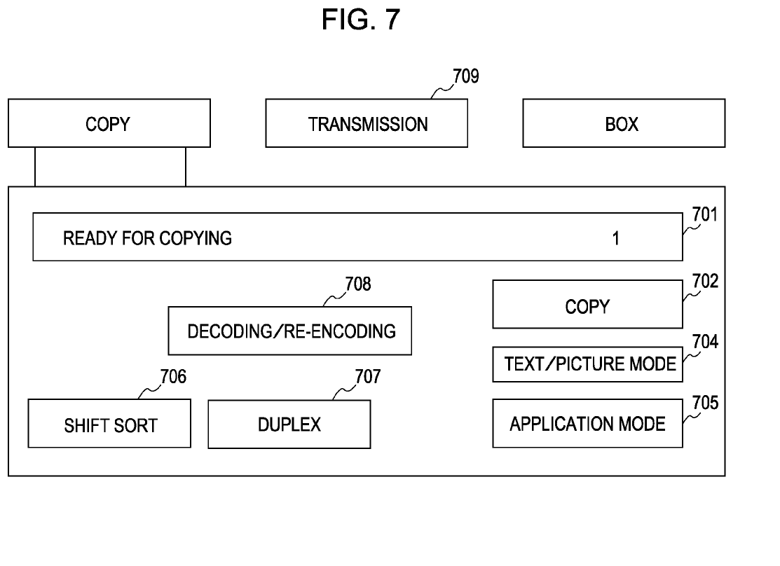

A filtering unit 502 appropriately corrects the spatial frequency of the received image data. For example, the filtering unit 502 performs an arithmetic operation on the received image data using a 7×7 matrix. In a copying machine or a multifunction machine, a tab 704 shown in FIG. 7 is pressed to select a text mode, a picture mode, or a text/picture mode as a copy mode. When the user selects the text mode, the filtering unit 502 applies a text filter to the entire image data. When the picture mode is selected, the filtering unit 502 applies a picture filter to the entire image data. When the text/picture mode is selected, the filtering unit 502 adaptively switches between the filters on a pixel-by-pixel basis according to a text/picture determination signal (part of the attribute data), as described below. That is, the picture filter or the text filter is determined on a pixel-by-pixel basis. The picture filter has a coefficient for smoothing out only the high-frequency components. Thus, surface roughness in the image can be reduced. The text filter has a coefficient strong edge enhancement. Thus, character sharpness is increased.

A histogram generation unit 503 samples the brightness data of the pixels constituting the received image data. More specifically, the histogram generation unit 503 samples brightness data within a rectangular region defined by specified main-scanning start and end points and sub-scanning start and end points with a constant pitch in the main-scanning and sub-scanning directions. The histogram generation unit 503 generates histogram data on the basis of the sampling results. The generated histogram data is used to estimate the level of the ground in a ground removing process. An input-side gamma correction unit 504 performs conversion into brightness data with non-linear characteristics using a table or the like.

A color/monochrome determining unit 505 determines whether each of the pixels constituting the received image is chromatic or achromatic, and adds the determination results to the image data as color/monochrome determination signals (part of the attribute data).

A text/picture determining unit 506 determines whether each of the pixels constituting the image data is a pixel constituting a character, a pixel constituting a halftone-dot area, a pixel constituting a character in a halftone-dot area, or a pixel constituting a solid image on the basis of the pixel value of the pixel of interest and the pixel values of the neighboring pixels. A pixel that is not any of the above pixels is a pixel constituting a white area. The text/picture determining unit 506 adds the determination results to the image data as text/picture determination signals (part of the attribute data).

If the image data output from the masking unit 501 includes encoded image data, a decoding unit 507 detects the encoded image data, and decodes the detected encoded image data to obtain information.

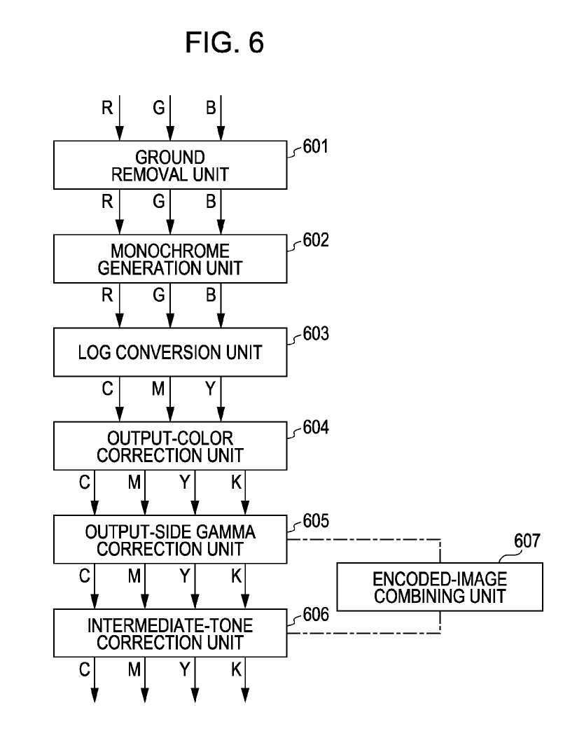

FIG. 6 shows the flow of the process performed by the printer image processing unit 315.

A ground removal unit 601 removes (or eliminates) the ground color of the image data using the histogram generated by the scanner image processing unit 312. A monochrome generation unit 602 converts color data into monochrome data. A LOG conversion unit 603 performs brightness-density conversion. For example, the LOG conversion unit 603 converts input RGB image data into CMY image data. An output-color correction unit 604 performs output-color correction. For example, the output-color correction unit 604 converts input CMY image data into CMYK image data using a table or matrix. An output-side gamma correction unit 605 performs correction so that the signal values input to the output-side gamma correction unit 605 and the reflection density of the output copy are proportional to each other. An encoded-image combining unit 607 is capable of combining encoded image data generated using an encoding process, as described below, and the image data (of the original document) and outputting composite image data. An intermediate-tone correction unit 606 performs intermediate-tone processing according to the number of tones output by the printer unit 14. For example, the intermediate-tone correction unit 606 performs binarization or 32-valued processing on the received high-tone image data.

The processors in the scanner image processing unit 312 and the printer image processing unit 315 can also output the received image data without performing any processing. In the following description, data transferred through a certain processor without being subjected to any processing is referred to as “data passing through the processor”.

The CPU 301 is capable of performing control to encode predetermined information to generate encoded image data. The predetermined information includes, for example, apparatus numbers, printing-time information, user ID information, and print-job ID information. The print-job ID information indicates an ID unique to a print job. For example, if the print job includes a plurality of pages, the same print-job ID information is assigned to the plurality of pages.

The term encoded image, as used herein, means an image such as a two-dimensional coded image or bar-coded image, or a digitally watermarked image generated using a digital watermarking technique.

The CPU 301 is also capable of performing control to transmit the generated encoded image data to the encoded-image combining unit 607 in the printer image processing unit 315 using a data bus (not shown).

The CPU 301 performs the above-described control operations (i.e., generation of an encoded image and transmission of the encoded image) by executing a program stored in the RAM 302.

FIG. 7 shows an initial screen displayed in the image forming apparatus 10. A field 701 indicates whether or not the image forming apparatus 10 is ready for copying, and also indicates the number of designated copies. A document selection tab 704 is a tab for selecting a document type. When the document selection tab 704 is pressed, a pop-up menu of three options, namely, text, picture, text/picture modes, is displayed. A finishing tab 706 is a tab for various finishing setups (e.g., shift sort). A duplex setting tab 707 is a tab for making settings for duplex-scanning and duplex-printing to allow scanning of both sides of a sheet and printing on both sides of a sheet. A reading (copy) mode tab 702 is a tab for selecting a document-reading mode. When the reading mode tab 702 is pressed, a pop-up menu of three options, namely, color, black, and automatic color selection (ACS) modes, is displayed. When the color mode is selected, color copying is performed. When the black mode is selected, monochrome copying is performed. When the ACS mode is selected, the copy mode is determined according to the monochrome/color determination signal described above.

A field 708 is a tab for selecting a process for combining the encoded image with the scanned document image and outputting the composite image onto a sheet. The encoded image includes the predetermined information described above (such as apparatus numbers, printing-time information, user ID information, and print-job ID information). The field 708 is hereinafter referred to as a “master-copy creation tab” 708. Also, an application mode tab 705 is provided.

A field 709 is a tab for setting the image forming apparatus 10 into a transmission mode. The transmission mode is described below.

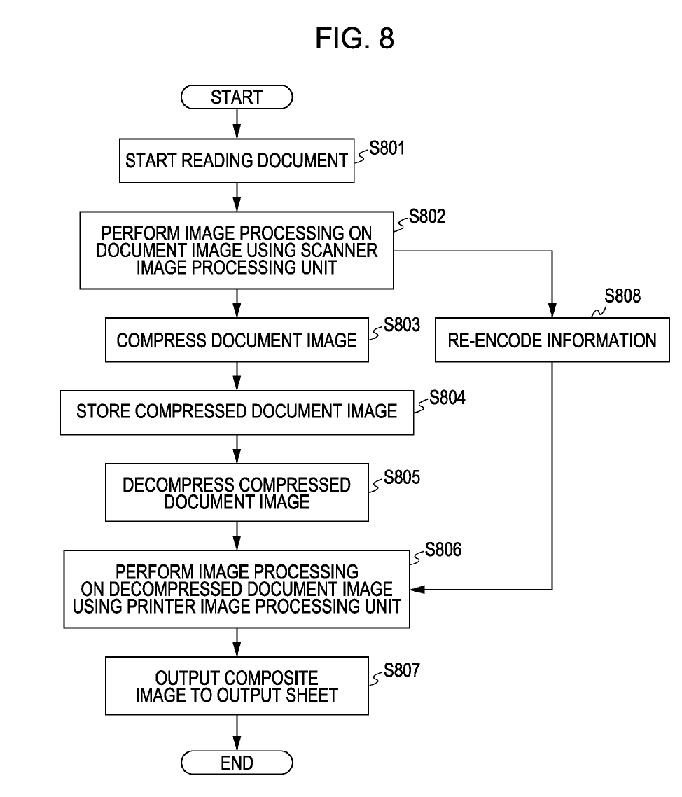

FIG. 8 is a flowchart showing a master-copy creation process performed when the user presses a start key after pressing the master-copy creation tab (decoding/re-encoding tab) 708 shown in FIG. 7.

In step S801, the CPU 301 performs control to transmit a document read by the scanner unit 13 as image data to the scanner image processing unit 312 via the scanner I/F 311.

In step S802, the scanner image processing unit 312 performs the operation shown in FIG. 5 on the image data to generate new image data and attribute data. The scanner image processing unit 312 further adds the attribute data to the image data. When the processing of step S802 has been completed, the processing of step S808 and the processing of step S803 start at the same time.

In step S808, the CPU 301 performs control to re-encode the decoded information to generate an encoded image, and to transmit the generated re-encoded image data to the encoded-image combining unit 607 in the printer image processing unit 315.

In step S803, the compression unit 313 divides the new image data generated by the scanner image processing unit 312 into blocks each having 32 pixels by 32 pixels to generate tile data. The compression unit 313 further compresses image data formed of the plurality of tile data.

In step S804, the CPU 301 performs control to transmit the image data compressed by the compression unit 313 to the RAM 302 for storage. The image data is transmitted to the image conversion unit 317 to perform image processing, if necessary, and the resulting image data is transmitted to the RAM 302 again for storage.

In step S805, the CPU 301 performs control to transmit the image data stored in the RAM 302 to the decompression unit 316. In step S805, further, the decompression unit 316 decompresses the image data. The decompression unit 316 further converts the decompressed image data formed of the plurality of tile data into raster image data. The converted raster image data is transmitted to the printer image processing unit 315.

In step S806, the printer image processing unit 315 edits the image data according to the attribute data added to the image data. The processing of step S806 corresponds to the operation shown in FIG. 6. In step S806, the encoded image data generated in step S808 and the image data (of the original document) are combined. More specifically, the encoded-image combining unit 607 combines the image data (of the original document) output from the output-side gamma correction unit 605 and the encoded image data generated in step S808. The intermediate-tone correction unit 606 performs intermediate-tone processing on the resulting composite image data according to the number of tones output by the printer unit 14. The composite image data subjected to intermediate-tone processing is transmitted to the printer unit 14 via the printer I/F 314.

In step S807, the printer unit 14 forms an image based on the composite image on an output sheet.

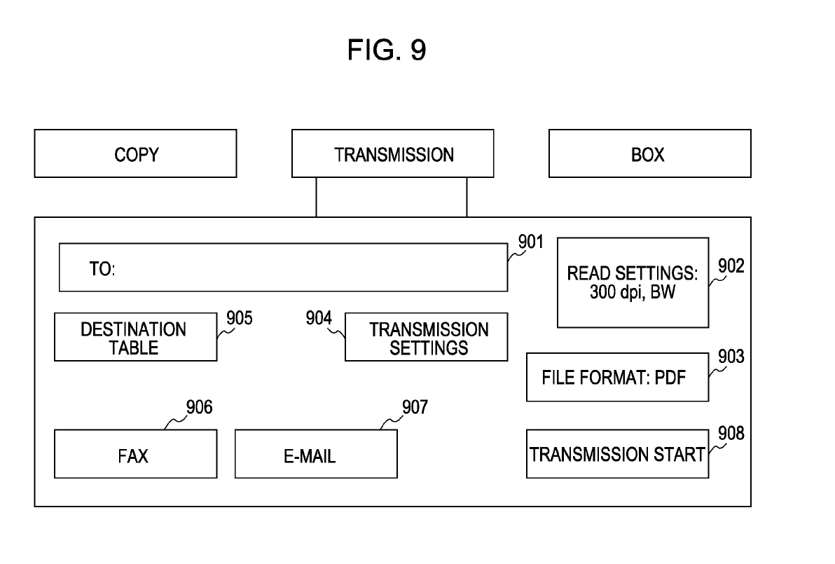

FIG. 9 shows a transmission screen displayed in the image forming apparatus 10. The transmission screen is displayed by pressing the field 709 shown in FIG. 7. A field 901 indicates a transmission destination designated for the image forming apparatus 10. A field 902 indicates the read settings. When the field 902 is pressed, a list of image scanning resolutions and a list of monochrome and color scanning options are displayed to allow the user to select settings. A field 903 indicates the format of the transmission data. When the field 903 is pressed, a list of data formats into which the format of the scanned image can be converted is displayed to allow the user to select one of them. A field 904 is a transmission setting menu field. When the field 904 is pressed, transmission settings such as duplex scanning (duplex-scanning mode, duplex-scanning transmission mode) and transmission after copying in 2-in-1 style, are performed. A field 905 is a destination table menu field. When the field 905 is pressed, a list of registered transmission destinations is displayed. A selected destination is displayed in the field 901. A field 906 is a menu field for instructing transmission via facsimile (fax). When the field 906 is pressed, a screen for entering a fax number is displayed. The entered value is displayed in the field 901. A field 907 is a menu field for instructing transmission via e-mail. When the field 907 is pressed, a screen for entering an e-mail address is displayed. The entered value is displayed in the field 901. A field 908 is a transmission start tab. When the field 908 is pressed, transmission to the destination shown in the field 901 is started. The transmission process is described below.

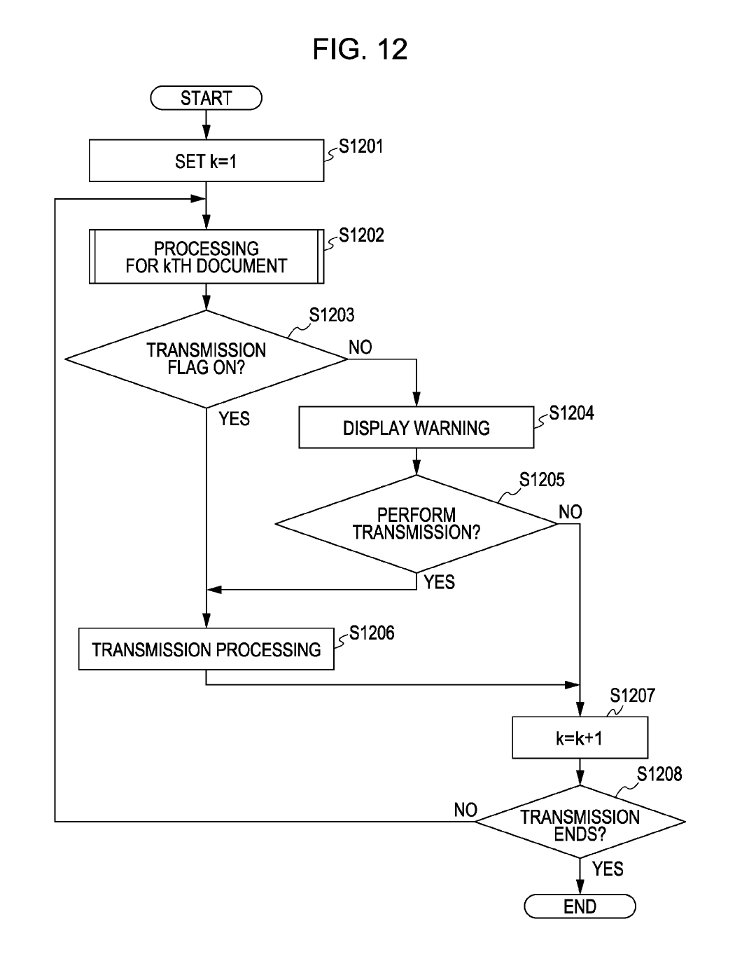

FIG. 12 is a flowchart showing a transmission process performed when the user presses the start key after pressing the transmission start tab 908 shown in FIG. 9.

In step S1201, the CPU 301 performs control to set k=1. The document on the first page is a document scanned first by the scanner unit 13, and the document on the second page is a document scanned second by the scanner unit 13. In general, the document on the k-th page is a document scanned in the k-th order by the scanner unit 13.

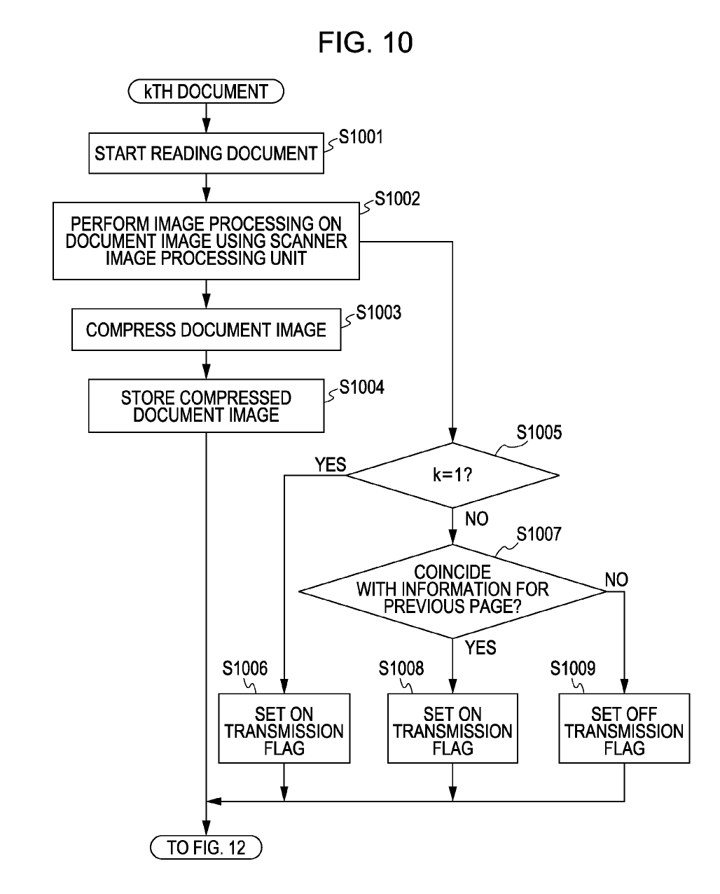

In step S1202, the document on the k-th page is processed. The process for the document on the k-th page is described in detail below with reference to FIG. 10.

In step S1203, the CPU 301 performs control to determine whether or not a transmission flag is turned on. If the transmission flag is turned off, the process proceeds to step S1204, and the CPU 301 displays a warning on a display screen of the operation unit 12. Then, the CPU 301 performs control to prohibit the transmission of the document on the k-th page. If the transmission flag is turned on, the process proceeds to step S1206 (transmission processing). The transmission processing of step S1206 is described below.

The warning on the display screen notifies the user of the existence of a wrong page using a message, e.g., “A wrong page is found. Do you continue to send the document?”. On the warning screen, the user selects whether to continue or terminate the transmission.

In step S1205, the CPU 301 performs control to determine whether continuation or termination of the transmission has been selected.

If it is determined that continuation of the transmission has been selected, the process proceeds to step S1206 (transmission processing). In step S1206, the compressed document image stored in the RAM 302 is transmitted to the outside via the network I/F 306 or the modem 307. Then, the process proceeds to step S1207, and increments the value k by one.

If it is determined that termination of the transmission has been selected, the process proceeds to step S1207. In step S1207, the value k is incremented by one.

In step S1208, the CPU 301 determines whether or not the transmission of all sheets of paper has been completed. If it is determined that all the sheets of paper stacked on the tray 202 have been processed, the process ends. If it is determined that all the sheets of paper stacked on the tray 202 have not been processed, the process proceeds to step S1202.

In the first embodiment, when the transmission flag for the document on the k-th page is turned on, the document on the k-th page is automatically transmitted.

Alternatively, documents having a plurality of pages may be stored in a memory or an HDD, and the transmission process may be started when it is determined that the transmission flag for all the plurality of pages is turned on.

Thereby, for example, when the document on the first page of is a wrong document (a document inserted by mistake) and the document on the second page is a correct document, the transmission of the wrong document can be prevented.

The mechanism in which the transmission process may be performed when it is determined the transmission flag for all pages is turned on also applies to other embodiments.

The processing of step S1202 for the document on the k-th page will be described with reference to FIG. 10. In step S1001, the CPU 301 performs control to transmit the document on the k-th page read by the scanner unit 13 as image data to the scanner image processing unit 312 via the scanner I/F 311.

In step S1002, the scanner image processing unit 312 performs the operation shown in FIG. 5 on the image data to generate new image data and attribute data. The scanner image processing unit 312 further adds the attribute data to the image data. If encoded image data exists, the decoding unit 507 in the scanner image processing unit 312 detects the encoded image data.

If encoded image data exists, the decoding unit 507 decodes the detected encoded image data to obtain information. The obtained decoded information is transmitted to the RAM 302 using a data bus (not shown). If encoded image data does not exist, information indicating the non-existence of encoded image data is transmitted to the RAM 302 using the data bus (not shown). The RAM 302 stores the transmitted information.

When the processing of step S1002 has been completed, the processing of step S1005 and the processing of step S1003 start at the same time. In step S1003, the document image is compressed and then stored in step S1004.

In step S1005, it is determined whether k=1 is set. If it is determined that k=1 is set, the current document is the first page. In this case, the process proceeds to step S1006, and the transmission flag is turned on. If it is determined that the value k is not 1, the current document is the second or any subsequent page. In this case, the process proceeds to step S1007.

In step S1007, after the start key is pressed, it is determined whether the information stored in the RAM 302 during the processing of the current k-th page is different from the information stored in the RAM 302 during the processing of the (k-1)-th page.

If it is determined that the information for the k-th page coincides with the information for the (k-1)-th page, the process proceeds to step S1008, and the CPU 301 performs control to turn on the transmission flag. If it is determined that both pieces of information do not coincide with each other, the process proceeds to step S1009, and the CPU 301 performs control to turn off the transmission flag.

According to the process described above, therefore, a plurality of documents including a wrong document can be prevented from being output to the outside.

### Second Exemplary Embodiment

In the first embodiment, a warning is displayed when even one page of a different type of document exists. In a second embodiment of the present invention, a warning is displayed only when the duplex-scanning transmission mode is set. The significance of the structure of the second embodiment will be described in detail with respect to an example.

For example, in modern society, many companies conduct business using paper documents. A large number of companies undertake work from a plurality of clients. A company undertaking work from a plurality of clients is hereinafter referred to as “Company A”, and the plurality of clients are hereinafter referred to as “Company B” and “Company C”.

In Company A, it is assumed that document data having a plurality of pages relating to Company B is printed on first sides of sheets. It is further assumed that the sheets that are no longer necessary are stacked on a sheet feeder of a multifunctional machine for re-use. That is, other documents (for example, documents relating to Company C) are printed on second sides of the sheets.

The re-used sheets have the information relating to Company C and the information relating to Company B. Such re-used sheets may result in leakage of confidential information. There is a possibility that a staff member of Company A may accidentally press a duplex-scanning transmission button for performing a transmission operation after scanning both sides of a sheet (hereinafter referred to as a “duplex-scanning transmission operation”) when the re-used sheets are stacked in a scanner unit of the multifunctional machine. There is another possibility that after a person performs a duplex-scanning transmission operation, another person may also perform a duplex-scanning transmission operation because he/she is not aware that the duplex-scanning transmission setting is still active.

If the documents relating to Company C are subjected to the duplex-scanning transmission operation, the information relating to Company B may be sent to Company C. Special care should therefore be taken when handling such re-used sheets.

The second embodiment provides a technique for prohibiting a duplex-scanning transmission operation for re-used sheets or providing a warning.

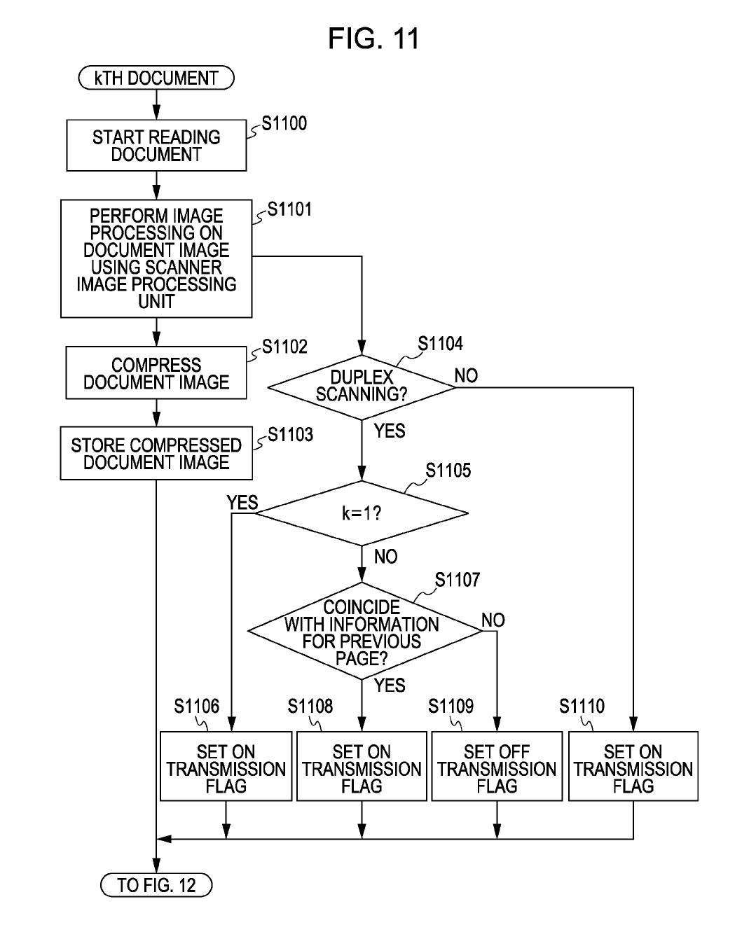

With regard to the second embodiment, only the difference from the first embodiment will be described with reference to FIG. 11. That is to say, steps S1100, S1102, S1103, S1106 and S1108 are, respectively, similar to steps S1001, S1003, S1004, S1006 and S1008, and therefore description of the same will be omitted.

FIG. 11 is a flowchart showing a transmission process performed when the user presses the start key after pressing the transmission start tab 908 shown in FIG. 9.

In the second embodiment, the processing of step S1104 is provided between the processing of step S1101 and the processing of step S1105.

In step S1104, the CPU 301 performs control to determine whether or not the duplex-scanning transmission mode is set. The user can select the duplex-scanning transmission mode by operating the field 904 on the operation screen (see FIG. 9).

When the duplex-scanning transmission mode has been selected, the CPU 301 determines in step S1104 that the duplex-scanning transmission mode is set.

If it is determined that the duplex-scanning transmission mode is set, the process proceeds to step S1105. If it is determined in step S1104 that the duplex-scanning transmission mode is not set, the process proceeds to step S1110, and the transmission flag is turned on.

In the second embodiment as well as in first embodiment, it is determined in step S1107 (step S1007) whether or not the information stored for the document on the k-th page coincides with the information stored for the document on the (k-1)-th page. If both pieces of information do not coincide with each other, the process proceeds to step S1109 (step S1009).

Therefore, even in the case where the document on the first page has an encoded image and the document on the second page is blank, a warning screen is displayed because those documents include different types of information.

In order to solve this problem, in step S1107, as well as the determination as to whether or not the information stored for the document on the k-th page coincides with the information stored for the document on the (k-1)-th page, the following operation may be performed. That is, if it is determined that both pieces of information do not coincide with each other, it may be determined whether or not the information stored for the document on the (k-1)-th page and the information stored for the document on the k-th page are information obtained by decoding the encoded image data. The process may proceed to step S1009 only when both pieces of information are information obtained by decoding the encoded image data.

That is, the CPU 301 may perform control to advance the process to step S1008 (in which the transmission flag is turned on) if it is determined that any of the conditions (1) to (3) below is satisfied:
(1) the case where the document on the (k-1)-th page does not include an encoded image;
(2) the case where the document on the k-th page does not include an encoded image; and
(3) the case where the information for the document on the k-th page coincides with the information for the document on the (k-1)-th page.

If none of the conditions (1) to (3) is satisfied, the CPU 301 performs control to advance the process to step S1009.

### Third Exemplary Embodiment

In the second embodiment, a warning screen is displayed when the first and second sides of a sheet include different information. In practical use, some users desire to transmit documents having a plurality of pages that include encoded images having different types of information.

However, in the case where a first side of the first sheet (the first page) has information A, a second side of the first sheet (the second page) has information B, and the first side of the second sheet (the third page) has the information A, those sheets are possibly sheets re-used by the user.

The same applies to the case where the second side of the first sheet (the second page) has information A, the first side of the second sheet (the third page) has information B, and the first side of the second sheet (the fourth page) has the information A.

That is, in the case where first sides of sheets have the same information and second sides of the sheets have information different from the information on the first sides, the possibility of re-using the sheets is significantly high. Alternatively, in the case where second sides of sheets include the same information and the information on first sides of the sheets is not identical to the information on the second sides, the possibility of re-using the sheets is significantly high.

In a third embodiment of the present invention, the CPU 301 performs the following control process.

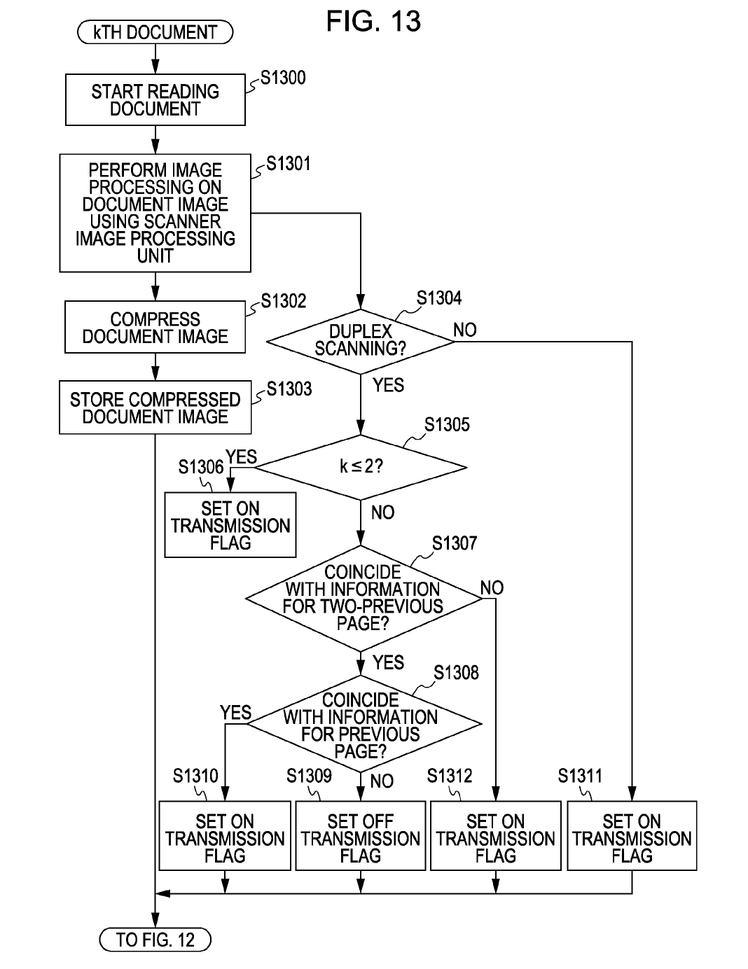

FIG. 13 is a flowchart showing a transmission process performed when the user presses the start key after pressing the transmission start tab 908 shown in FIG. 9.

In step S1300, the CPU 301 performs control to transmit the document on the k-th page read by the scanner unit 13 as image data to the scanner image processing unit 312 via the scanner I/F 311.

In step S1301, the scanner image processing unit 312 performs the operation shown in FIG. 5 on the image data to generate new image data and attribute data. The scanner image processing unit 312 further adds the attribute data to the image data. If encoded image data exists, the decoding unit 507 in the scanner image processing unit 312 detects the encoded image data.

If encoded image data exists, the decoding unit 507 decodes the detected encoded image data to obtain information. The obtained decoded information is transmitted to the RAM 302 using a data bus (not shown). If encoded image data does not exist, information indicating the non-existence of encoded image data is transmitted to the RAM 302 using the data bus (not shown). The RAM 302 stores the transmitted information.

When the processing of step S1301 has been completed, the processing of step S1304 and the processing of step S1302 start at the same time. The processing of steps S1302 and S1303 are similar to the processing of steps S1102 and S1103, respectively, and a description thereof is thus omitted.

In step S1304, it is determined whether or not duplex-scanning mode is set. Since the process shown in FIG. 13 is performed in the transmission mode, the duplex-scanning mode may be also be referred to as the duplex-scanning transmission mode. If the duplex-scanning transmission mode is set, the process proceeds to S1305. If the duplex-scanning transmission mode is not set, the process proceeds to step S1311, and the transmission flag is turned on.

In step S1305, it is determined whether or not the value k is 2 or less. If it is determined that the value k is 2 or less, the current document is the first or second page. In this case, the process proceeds to step S1306, and the transmission flag is turned on. If it is determined that the value k is 3 or more, the current document is the third or any subsequent page. In this case, the process proceeds to step S1307.

In step S1307, it is determined whether or not the information stored in the RAM 302 during the processing of the current k-th page is different from the information stored in the RAM 302 during the processing of the (k-2)-th page.

If it is determined that the information for the k-th page does not coincide with the information for the (k-2)-th page, the process proceeds to step S1312, and the CPU 301 performs control to turn on the transmission flag. If it is determined that both pieces of information coincide with each other, the CPU 301 performs control to advance the process to step S1308.

In step S1308, it is determined whether or not the information stored in the RAM 302 during the processing of the current k-th page is different from the information stored in the RAM 302 during the processing of the (k-1)-th page.

If it is determined that the information for the k-th page does not coincide with the information for the (k-1)-th page, the process proceeds to step S1309, and the CPU 301 performs control to turn off the transmission flag. If it is determined that both pieces of information coincide with each other, the CPU 301 performs control to advance process to step S1310.

### Other Exemplary Embodiments

The present invention can also be applied to a system including a plurality of apparatuses (such as a computer, an interface device, a reader, and a printer) or an apparatus including a single device (such as a multifunction apparatus, a printer, or a facsimile machine).

It is to be understood that the advantages of the present invention are achieved by providing a system or an apparatus with a storage medium storing program code implementing the steps of the flowcharts in the embodiments described above so that a computer (or a CPU or a micro-processing unit (MPU)) of the system or apparatus can read and execute the program code stored in the storage medium. In this case, the functions of the embodiments described above are achieved by the program code read from the storage medium. Therefore, the program code and the storage medium storing the program code constitute embodiments of the present invention.

Examples of the storage medium for supplying the program code may include a floppy disk, a hard disk, an optical disk, a magneto-optical disk, a compact disk read-only memory (CD-ROM), a compact disc readable (CD-R), a magnetic tape, a non-volatile memory card, and a ROM.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-173620 filed Jun. 23, 2006, which is hereby incorporated by reference herein in its entirety.

What is claimed is:

1. An image processing apparatus comprising:
a first obtaining unit configured to obtain information by decoding an encoded image included in a document image on a first page;
a second obtaining unit configured to obtain information by decoding an encoded image included in a document image on a second page different from the first page; and
a controller configured to determine whether or not the information obtained by the first obtaining unit and the information obtained by the second obtaining unit coincide with each other and to perform control to prohibit transmission of at least one of the document image on the first page and the document image on the second page when it is determined that the information obtained by the first obtaining unit and the information obtained by the second obtaining unit do not coincide with each other.

2. The image processing apparatus according to claim 1, wherein the controller performs control to transmit both the document image on the first page and the document image on the second page when it is determined that the information obtained by the first obtaining unit and the information obtained by the second obtaining unit coincide with each other.

3. The image processing apparatus according to claim 1, wherein the controller includes a duplex-scanning-mode determining unit configured to determine whether or not a duplex-scanning mode is set, and
when the duplex-scanning-mode determining unit determines that the duplex-scanning mode is set, the controller determines whether or not the information obtained by the first obtaining unit and the information obtained by the second obtaining unit coincide with each other, and performs control to prohibit transmission of at least one of the document image on the first page and the document image on the second page when it is determined that the information obtained by the first obtaining unit and the information obtained by the second obtaining unit do not coincide with each other, and
when the duplex-scanning-mode determining unit determines that the duplex-scanning mode is not set, the controller performs control to transmit both the document image on the first page and the document image on the second page.

4. The image processing apparatus according to claim 3, further comprising a reader configured to read a sheet and generate a document image,
wherein the document image on the second page is generated by the reader after the document image on the first page.

5. The image processing apparatus according to claim 4, wherein the document image on the second page is an image generated by the reader as a page subsequent to the document image on the first page.

6. The image processing apparatus according to claim 1, further comprising a third obtaining unit configured to obtain information by decoding an encoded image included in a document image on a third page different from the first page and the second page,
wherein the controller determines whether or not the information obtained by the third obtaining unit and the information obtained by the second obtaining unit coincide with each other, and
the controller performs control to prohibit transmission of at least one of the document image on the first page, the document image on the third page, and the document image on the second page when it is determined that the information obtained by the first obtaining unit and the information obtained by the second obtaining unit do not coincide with each other and when it is determined that the information obtained by the third obtaining unit and the information obtained by the second obtaining unit coincide with each other.

7. The image processing apparatus according to claim 6, further comprising a reader configured to read a sheet and generate a document image,
wherein the document image on the second page is an image generated by the reader as a page subsequent to the document image on the third page, and the document image on the third page is an image generated by the reader as a page subsequent to the document image on the first page.

8. A method for controlling an image processing apparatus, the method comprising:
a first obtaining step of obtaining information by decoding an encoded image included in a document image on a first page;
a second obtaining step of obtaining information by decoding an encoded image included in a document image on a second page different from the first page; and
a controlling step of determining whether or not the information obtained in the first obtaining step and the information obtained in the second obtaining step coincide with each other, and performing control to prohibit transmission of at least one of the document image on the first page and the document image on the second page when it is determined that the information obtained in the first obtaining step and the information obtained in the second obtaining step do not coincide with each other.

9. The method according to claim 8, wherein the controlling step performs control to transmit both the document image on the first page and the document image on the second page when it is determined that the information obtained in the first obtaining step and the information obtained in the second obtaining step coincide with each other.

10. The method according to claim 8, wherein the controlling step includes a duplex-scanning-mode determining step of determining whether or not a duplex-scanning mode is set,
when it is determined in the duplex-scanning-mode determining step that the duplex-scanning mode is set, the controlling step determines whether or not the information obtained in the first obtaining step and the information obtained in the second obtaining setup coincide with each other, and performs control to prohibit transmission of at least one of the document image on the firs page and the document image on the second page when it is determined that the information obtained in the first obtaining step and the information obtained in the second obtaining step do not coincide with each other, and
when it is determined in the duplex-scanning-mode determining step that the duplex-scanning mode is not set, the controlling step performs control to transmit both the document image on the first page and the document image on the second page.

11. The method according to claim 10, further comprising a reading step of reading a sheet and generating a document image,
wherein the document image on the second page is an image generated in the reading step after the document image on the first page.

12. The method according to claim 11, wherein the document image on the second page is an image generated in the reading step as a page subsequent to the document image on the first page.

13. The method according to claim 8, further comprising a third obtaining step of obtaining information by decoding an encoded image included in a document image on a third page different from the first page and the second page,
wherein the controlling step determines whether or not the information obtained in the third obtaining step and the information obtained in the second obtaining step coincide with each other, and
the controlling step performs control to prohibit transmission of at least one of the document image on the first page, the document image on the third page, and the document image on the second page when it is determined that the information obtained in the first obtaining step and the information obtained in the second obtaining step do not coincide with each other and when it is determined that the information obtained in the third obtaining step and the information obtained in the second obtaining step coincide with each other.

14. The method according to claim 13, further comprising a reading step of reading a sheet and generating a document image,
wherein the document image on the second page is an image generated in the reading step as a page subsequent to the document image on the third page, and the document image on the third page is an image generated in the reading step as a page subsequent to the document image on the first page.

15. A computer-readable storage medium containing computer-executable instruction for controlling an image processing apparatus, the medium comprising:
computer-executable instructions for performing a first obtaining step of obtaining information by decoding an encoded image included in a document image on a first page;
computer-executable instructions for performing a second obtaining step of obtaining information by decoding an encoded image included in a document image on a second page different from the first page; and
computer-executable instructions for performing a controlling step of determining whether or not the information obtained in the first obtaining step and the information obtained in the second obtaining step coincide with each other, and performing control to prohibit transmission of at least one of the document image on the first page and the document image on the second page when it is determined that the information obtained in the first obtaining step and the information obtained in the second obtaining step do not coincide with each other.
